(19) United States
(12) Patent Application Publication
(10) Pub. No.: US 2007/0027509 A1
(43) Pub. Date: Feb. 1, 2007

(54) Automated panretinal laser photocoagulation

(76) Inventors: Elliot S. Eisenberg, San Francisco, CA (US); Tony Partono, San Francisco, CA (US)

Correspondence Address: Elliot S. Eisenberg, 1215 Greenwich # 4A, San Francisco, CA, 94109, US

(21) Appl. No.: 11/193,735

(22) Filed: Jul. 29, 2005

(51) Int. Cl. A61H 33/00

(52) U.S. Cl. 607/87

(57) ABSTRACT

A beam diverting laser adaptor is disclosed for automating panretinal photocoagulation (PRP). Particularly for use in ophthalmology and laser surgery the apparatus consists of an external casing (12) which is interposed in the laser pathway of a delivery system. Internally, a mobile disc (26) with edge gearing (20) is mounted with mirrors (22) (24) to deflect an incident beam. In close approximation to the rotary disc lies a stationary fenestrated bottom plate (36) for support. A micromotor (16) and shaft gearing (18) coupled to the device spin the top plate. Repetitive laser bursts are timed with the circumferential motion of the mobile plate by a cable (50) and a control box (52). This results in a ring of laser shots and permits a labor intensive treatment to be performed with greater speed, greater efficiency, and greater accuracy.

### CROSS-REFERENCE TO RELATED APPLICATIONS

This application is related to application U.S. Ser. No. 11/024,308, Filed 2004 Dec. 28 by one of the present inventors.

### FEDERALLY SPONSORED RESEARCH

Not Applicable

### SEQUENCE LISTING OR PROGRAM

Not Applicable

### BACKGROUND OF THE INVENTION

1. Field Of The Invention

The present invention relates to ophthalmic devices which facilitate the therapeutic delivery of laser energy to the interior of the eye.

2. Prior Art

Diabetes Mellitus is a significant health problem. Epidemiologists have estimated that over 17,000,000 Americans now have the disease and statistical models show that by the year 2025 approximately 25,000,000 will suffer from the disorder. On a worldwide basis 120,000,000 people are afflicted with the disease. While the disease has a number of medical complications that often increase with the duration of the illness few are as feared as diabetic retinopathy. In fact, this pathology is the most frequent cause of blindness among adults aged 20-74 years. Population based studies have shown the prevalence of diabetic retinopathy as a percentage of patients with diabetes ranges from 21% -47% with a median value of 36%. Furthermore, the Wisconsin Epidemiologic Study of Diabetic Retinopathy (WESDR) has linked the duration of the illness with an increasing prevalence of diabetic retinopathy. After 20 years of diabetes 99% of patients with Type 1 (early onset and Insulin dependent) disease will show some degree of retinopathy and 60% with Type 2 (adult onset and Non Insulin dependent) will similarly be afflicted.

In broad categories two kinds of retinopathy exist and they are termed ‘background’ (non-proliferative) and ‘proliferative.’ A current severity scale of clinical diabetic retinopathy sub classifies these disease forms into five stages. In stage 1 no retinal disease is seen, stage 2 reveals mild non-proliferative retinopathy, stage 3 discloses a moderate amount of retinal pathology, stage 4 is consistent with advanced or severe non-proliferative findings, and stage 5 is coded as the proliferative manifestation of this complication. Proliferative diabetic retinopathy, the most severe and visually threatening form of the disorder, is characterized by abnormal new blood vessels which grow on the surface of the retina and sometimes into the vitreous cavity of the eye. Sometimes the process is called neovascularization. As a result of the proliferation of these aberrant vascular channels leakage, bleeding, traction, neovascular glaucoma, and retinal detachments occur. Derangement of the underlying retina leads to visual loss and blindness. With a few additions, to be addressed later in this application, our substantive invention herein relates to the treatment of stage 4 and stage 5 diabetic refinopathy.

A multicentered clinical trial (Diabetic Retinopathy Study—DRS) that ran from 1971-1979 showed that the treatment of proliferative diabetic retinopathy with pan retinal photocoagulation (PRP) could reduce visual loss by 50-60%. Also termed scatter photocoagulation, PRP has remained the treatment of choice for proliferative disease for over 30 years. By mechanisms not completely understood panretinal photocoagulation usually reduces or eliminates the abnormal blood vessels which grow in this condition. Hence the goals of panretinal photocoagulation are to involute neovascular tissue, prevent further neovascularization, reduce the risks of vitreous hemorrhage, and decrease retinal detachments. Aside from being the mainstay of treatment for proliferative diabetic retinopathy panretinal photocoagulation (PRP) can be used to suppress neovascularization found in other ocular disease states. These include severe non-proliferative retinopathy (stage 4), optic disc neovascularization due to branch retinal vein occlusion, optic disc neovascularization due to central retinal vein occlusion, and neovascular glaucoma.

Three state of the art delivery formats are available to effectuate panretinal laser ablation (PRP). All three require manual treatments with a significant degree of operator dexterity. All three also require multiple, interrupted laser applications placed one at a time. And finally, all three require fifteen hundred (1500) to two thousand (2000) bums placed in a grid configuration within the interior of the diseased eye. Treatments typically are placed in a variable zone from the edge of the vascular arcades to the anterior peripheral retina. Thus the resulting ring or donut shape of laser applications involves three hundred sixty degrees within the internal eye. A full complement of treatment (1500-2000 spots) with two of the delivery formats is usually not completed in one patient/physician encounter. Instead, treatments are typically divided into two or three sessions lasting approximately twenty minutes each. Thus it may take sixty minutes to perform a complete panretinal photocoagulation on a single diseased eye. The procedure (PRP) is time consuming for both the patient and physician.

The first and most ubiquitously used format for ophthalmic laser delivery is the 1) slit-lamp(SL) system. In this system a laser source is connected to a biomicroscope via an optical fiber cable. This allows an examiner, with the aid of a fundus contact lens, to view the patient's retina and focus a laser beam in the interior of the eye. The fundus lenses allow different anatomical zones within the eye to be viewed. Typically the patient's cornea is treated with a topical anesthetic agent and the pupil is also pharmacologically dilated. Using a micromanipulator the physician can focus an attenuated laser beam at targets on the retinal surface. Activation of a variable beam size, power, and duration can be accomplished by depressing a foot switch trigger. In the process the treating doctor must steady a contact lens on the patient's eye, focus a slit-lamp illumination beam to bring the desired target into view, manipulate an aiming beam from point to point on the retinal surface, and trigger the device. The 500 micron sized bums or laser spots in panretinal photocoagulation are placed one shot at a time. In the past an attempt has been made to leave some space between each laser application. Over time, however, bums tend to coalesce depending on their absorption by underlying retinal pigment epithelial cells.

A second format for eye laser delivery is the 2) binocular laser indirect ophthalmoscope. Although somewhat analogous to the slit-lamp system this methodology employs the use of a headpiece worn by the treating physician. An optical cable from a laser source is connected to the top of a headband holding an an array of lenses and a reflecting mirror. A separate illumination beam is also contained within the apparatus to view the posterior segment of the eye. The treating physician must also hold a condensing lens freehand in front of the patient's eye in order to produce an inverted image of the retina. Both the illumination beam and the laser aiming beam are projected through the hand held lens into the patient's eye. The examiner's head position in relationship to the lens and the patient's eye is the main mechanism for imaging the retina and aiming the laser. An extremely small variation in spatial position can leave the treating surgeon out of focus or in the wrong locality for treatment. Likewise, a subtle shift in eye position or lid position by the patient can prevent adequate treatment As in the slit-lamp format triggering the laser is usually by a foot activated switch. A high degree of user coordination is mandatory with this approach to laser panretinal photocoagulation.

The third methodology for laser delivery to the internal eye is via an 3) endoprobe. This instrument is used during a microsurgical procedure (vitrectomy) which is often performed in an operating room setting. Unlike the aforementioned formats for laser delivery this is only done at the time of major eye surgery. It is not designed for office usage as it requires intraocular penetration. Basically, a proximal connector is adapted for interaction with a laser source. The endoprobe is a needle shaped or tubular handpiece held by the surgeon. An optical fiber cable extends from the proximal connector to a distal handpiece. After performing sclerotomies and subsequent vitreous removal the surgeon can execute pan retinal photocoagulation by hand holding the endoprobe in close proximity to the retinal surface. As in the other delivery modes a foot pedal can be activated to deliver laser bums one at a time. In some models a repeat mode insures the firing of the laser at a specific frequency set by the treating physician. While this can speed treatment somewhat it still requires the surgeon to aim the probe tip for each individual laser treatment. Furthermore, the endoprobe must be carefully steadied inside the eye since the distance between the probe Up and the retinal surface is critical for its performance. In addition, the treating doctor usually must illuminate the interior of the eye with the other hand using a manually held light pipe while simultaneously directing the endoprobe treatments. Accidentally contacting the retinal surface with the probe tip can result in hemorrhage or retinal holes. The treatment objectives in this format of panretinal photocoagulation are the same as in the slit lamp and binocular indirect systems. Mainly, 1500-2000 laser applications of approximately 500 microns are delivered to the interior of the eye. From a practical standpoint this format requires treatment by a specially trained retinal surgeon and cases with severe proliferative retinopathy requiring surgery. Also, an operating room setting with anesthesia coverage is usually necessary. Therefore it is the least utilized mechanism for panretinal delivery and not intended for widespread usage.

It would be desirable to provide a device that would reduce the time required for panretinal photocoagulation, a device that would reduce operator aiming errors, a device that would reduce the coordination necessary for treatment, a device that would reduce patient pain during the procedure, and a device that would reduce the complications of therapy. While prior inventors have addressed a few of these issues none have achieved the majority of these objectives. None have made significant inroads for automating the procedure. U.S. Pat. Nos. 6,066,128 and 5,921,981 to Bahmanyar et al. (2000) (1999) accurately discuss the three laser delivery systems for PRP and address the time intensity issue involved with therapy. Although proposing an optical mechanism to reduce treatment times they fail to make a huge reduction in treatment time. And, their invention does not deal with user coordination, aiming errors, patient pain, and the complications of panretinal laser treatment. Basically, they proposes a microlens array and a collimating lens interposed between the laser source and the laser delivery system. This structure allows the splitting of a single beam into four simultaneous laser beams. A spacer is used towards the distal end of the apparatus to hold optical fibers in a fixed geometric relationship. The authors purport the net effect is to position a multi-spot pattern on the retina with a single shot of the laser. It might follow that treatment times for panretinal photocoagulation could be reduced by one fourth the standard time (500 single activations of the laser could produce 2000 shots of treatment). However, the invention still has to be manually aimed by the treating surgeon one application at a time with all delivery formats. Thus it would not minimize aiming errors. And while the procedure duration may be reduced somewhat with a plurality of beams burning the retina in a single application, it would likely increase the pain of each individual bum and thus mandate anesthesia. Furthermore, the apparatus does not lessen the need for a high degree of user coordination in each of the delivery formats. Finally, with a normal contingent of panretinal laser applications as the end result there is no reason to assume the complications of the procedure would be reduced.

A binocular indirect laser ophthalmoscope format and its prior art are described in U.S. Pat. No. 6,830,355 to Gutridge (2004). A special attachment on their device enables the laser to be emitted on the central viewing axis of the binoculars and in the same plane as the binocular plane of sight. They assert this can make treatments faster and that pupillary dilation may not be as critical a factor in performing treatments. While that may be true their instrument for usage in panretinal photocoagulation still requires the operator to manually aim and trigger the laser beam shot by shot Furthermore, the instrument mandates extremely steady head position by the doctor and patient along with a lens which is held freehand in front of the patient's treated eye. For accurate laser placement coordination is critical, eye position is critical, and the head positions of both examiner and subject are critical.

Endoscopic lasering of the internal eye to achieve panretinal photocoagulation can be accomplished with devices (endoprobes) designed for intraoperative surgery. U.S. Pat. No. 4,865,029 to Pankratov (1989) and U.S. Pat. No. 5,147,349 to Johnson (1992) are examples. Each requires a surgical penetration of the eye wall to effectuate treatment Each requires carefully aiming of each laser application by a highly coordinated operator. Each is not conducive to treating large numbers of patients with proliferative diabetic retinopathy or other diseases requiring PRP. Each fails to minimize the complications of panretinal photocoagulation which are well documented. And finally, each is not a time efficient way of providing treatment.

3. Objects and Advantages

Accordingly, several objects and advantages of our invention are:
a) to provide a faster method of treatment for panretinal photocoagulation;
b) to provide a device which reduces user coordination for the treating surgeon;
c) to provide a methodology which diminishes operator aiming errors;
d) to provide an instrument which decreases patient pain with treatment;
e) to provide an adaptation that increases the safety of PRP;
f) to provide a way of decreasing complications of the laser surgery; and
g) to provide a method and article of manufacture that automates the delivery of panretinal photocoagulation.

Further objects and advantages of our invention will become apparent from a consideration of the drawings and the ensuing description.

### SUMMARY

The present invention is an article of manufacture and method for automating laser panretinal photocoagulation. It consists of a body or external housing, a micromotor with attached gearing to create rotational force, a rotary disc mounted with highly reflective mirrors or prisms to divert and redirect the path of laser beam energy, a supporting fenestrated bottom plate, a mechanism for attaching said device to a laser delivery system, and a cable connected to a control box.

### DRAWINGS—FIGURES

FIG. 1 shows that external casing of the device and the attached micromotor as seen in a lateral view.

FIG. 2 shows a top view of the invention looking down on the central mirror.

FIG. 3 shows an exploded view of the machine following the pathway of a laser beam.

FIG. 4 shows a lateral view of the solid rotary disc.

FIG. 5 shows a top view of the rotary disc engaging micromotor gearing.

FIG. 6 shows a side view of the stationary fenestrated bottom plate with peripheral threads.

FIG. 7 shows the fenestrated bottom plate with crosshair supports.

FIG. 8 shows a side view of the device sliding within a clip-on attachment mechanism.

FIG. 9 shows the device held by and in apposition to a clip-on attachment.

FIG. 10 shows the unit connected with a cable to a control box.

### DRAWINGS—REFERENCE NUMBERS

10 threaded ring

12 external ring casing

14 micromotor casing

16 micromotor

18 motor gearing

20 edge gearing

22 central mirror

24 peripheral mirror

26 solid rotary disc

28 central shaft with ring clamp

30 hole underlying peripheral mirror

32 central hole in bottom plate

34 cross hair supports

36 fenestrated bottom plate

38 threaded ring of bottom plate

40 incident laser path

42 laser beam exit

44 peripheral stabilizing shaft

46 groove

48 clip

50 attachment cable

52 control box

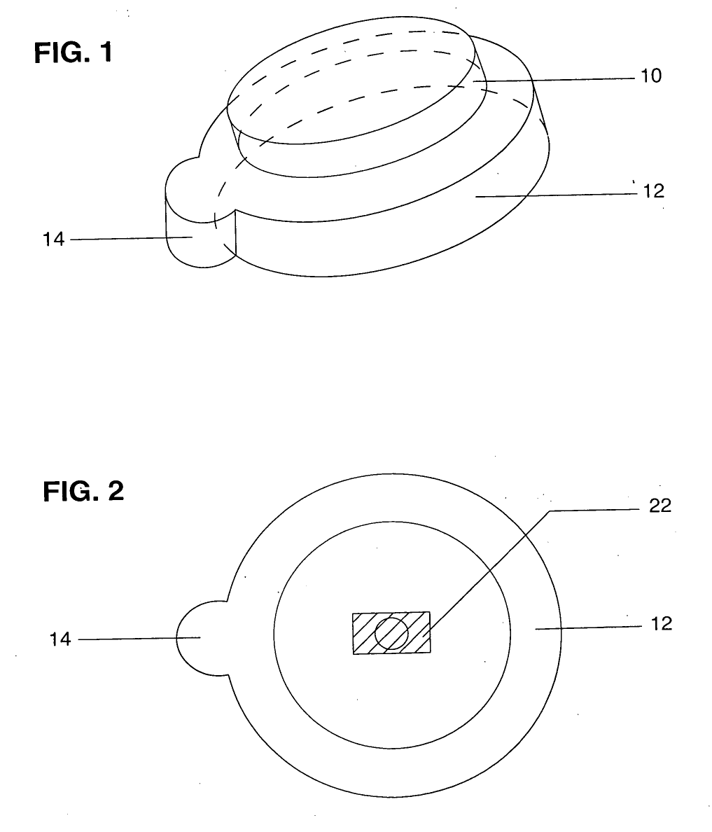

### DETAILED DESCRIPTION—PREFERRED EMBODIMENT—FIGS. 1-10

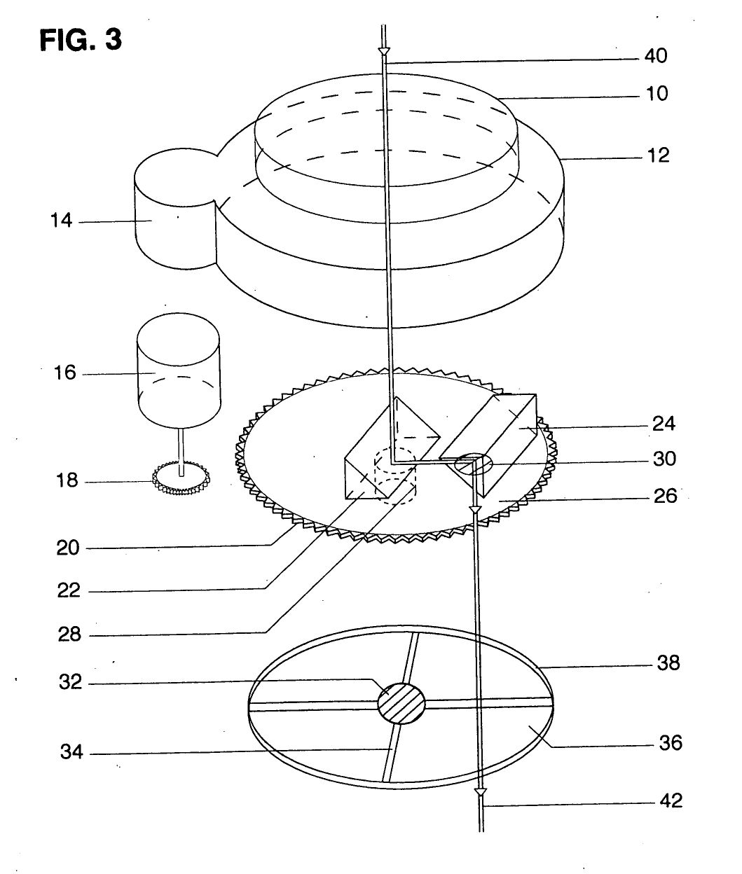

A preferred embodiment of the invention is shown in FIG. 1-10. The external housing of the laser adaptor is seen in FIG. 1 in a lateral view with the instrument tilted obliquely. Two annular rings are mounted in apposition with the top portion having a smaller diameter. The top ring contains a threaded edge 10 for mounting or screwing into the lens assembly in a laser delivery device. The external casing 12 of the lower ring contains an additional enclosure for the motor casing 14. A top view of the device's configuration is seen in FIG. 2 again showing casing 12 and 14. In addition, a central mirror 22 or prism is mounted internally within the instrument to divert the path of an incoming laser beam. FIG. 3 is an exploded view of the device showing its external and internal construction in detail. Within the casing of the laser instrument adaptor two discs and a micromotor are found. The first and superior plate is a rotary disc 26 that has two mirrors or prisms mounted on its surface. The edge of this solid plate has gearing 20. In the center lies angulated mirror 22 and below this highly polished reflecting device a shaft 28 is constructed. An incident laser beam 40 coming through the top of the device strikes the central mirror 22 and then is diverted to a peripheral mirror or prism 24. Below the mirror lies hole 30 allowing the deflected laser beam to pass through internally. On one side of the moving rotary disc 26 a micromotor 16 is placed. The shaft of the micromotor contains a small disc with edge gearing 18. The edge gearing of the motor is enmeshed with the gearing of the rotary disc so as to provide a rotational force to move the superior disc. A fenestrated bottom plate 36 lies connected to shaft 28 of the solid superior disc. In the preferred embodiment the bottom plate is slightly larger in diameter than the rotary disc above. A hole, 32, lies in the center of the bottom plate. It is designed to fit snugly through shaft 28 of the upper rotary disc. Crosshair supports 34 provide stability for the nonmobile bottom plate. On the edge of the fenestrated bottom plate a threaded ring 38 is found. Most of the bottom plate is open to allow a diverted laser beam 42 to pass through unimpeded. In the preferred embodiment it is anticipated that the displaced laser beam will then pass to a final mirror within a laser delivery device such as a slit lamp. At that juncture it will be reflected to a fundus contact lens and subsequently into the posterior segment of a patient's eye.

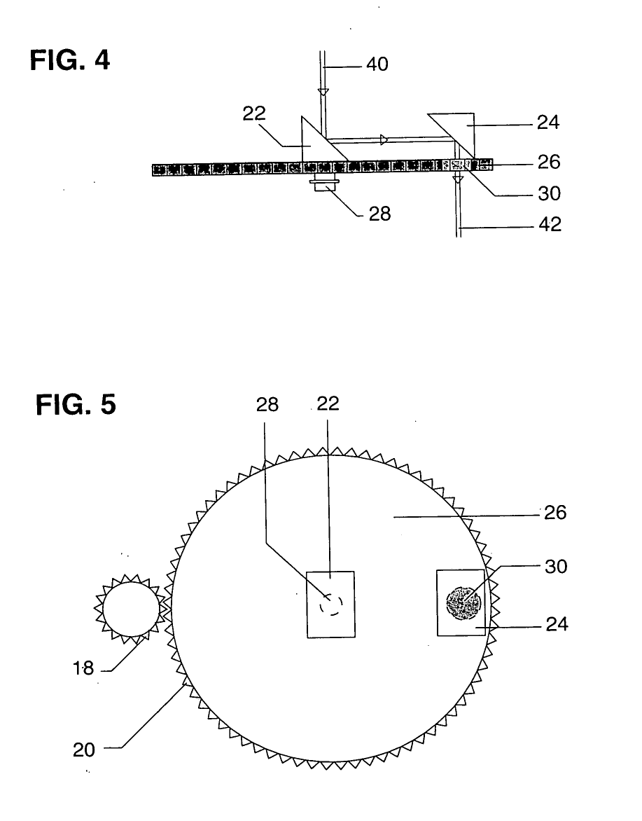

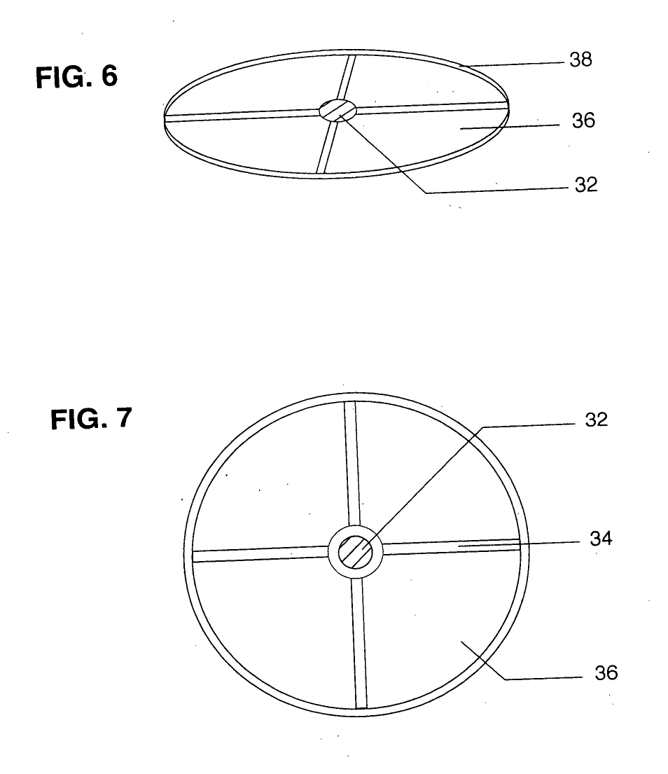

FIGS. 4-7 show the internal discs of the invention seen from side and top views. In the first instance FIG. 4 gives a perspective of the solid rotary disc with edge gearing 26 as seen from the side. Incoming laser beam 40 is shown striking an angulated reflecting device 22 and is subsequently deflected 90 degrees horizontally towards peripheral mirror 24 which lies near the edge of the disc. After another deflection the laser light passes through hole 30 on its way through the inferior fenestrated bottom plate connected to shaft 28. In this embodiment a ring clamp on shaft 28 can be used to secure a stable fit with the bottom plate. A top view of the solid rotary disc 26 is constructed in FIG. 5 along with a perspective showing micromotor edge gearing 18 connected to the assembly. Beneath central mirror 22 lies shaft 28 as a connector for the lower stationary bottom plate. Hole 30 similarly lies below peripheral mirror 24. As in FIG. 4 edge gearing 20 (FIG. 5) circumscribes 360 degrees of the rotary disc. The lower bottom plate 36 is depicted in FIG. 6 in a side view. A central hole 32 is shown to provide an assembly for shaft 28 of the superior rotary disc. Crosshair supports 34 pass from the edges of the disc to the central hole. The edge of the bottom plate contains screwed threads 38. A top view of bottom plate 36 is noted in FIG. 7 where it is evident that most of the disc is fenestrated. Although providing support this facilitates an unimpeded path for the therapeutic laser light.

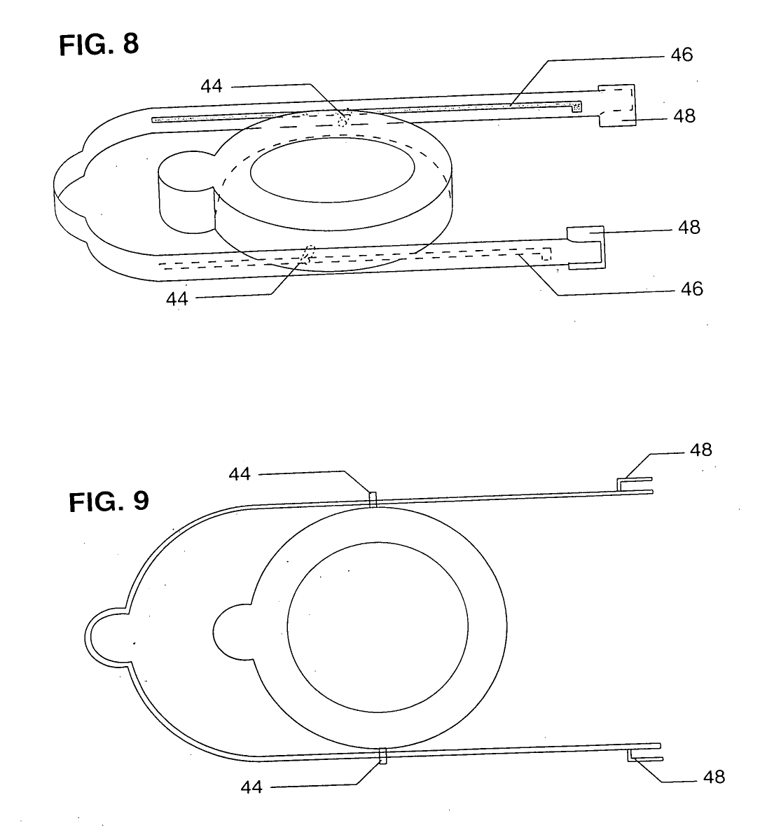

FIGS. 8-9 show one embodiment of attachment for the invention to the laser delivery instrument. A side view in FIG. 8 depicts the invention lying within the arms of a clip-on apparatus. End clips, 48, are seen on one end of the device for attachment to the laser. Proximal to the end clips a groove 46 is noted within the arms of the attachment mechanism. Shafts 44 lie within the groove and are attached to the invention. It is anticipated that this will provide a sliding action that will allow the device to move in or out of the laser beam path. FIG. 9, a top view, shows the invention fitting within the U shaped arms a clip-on attachment. Shafts 44 hold the device in groove 46 so that it can be moved and stabilized as a unit The distal end of the apparatus will contain clip attachments 48 to fasten and integrate the invention to the laser delivery system.

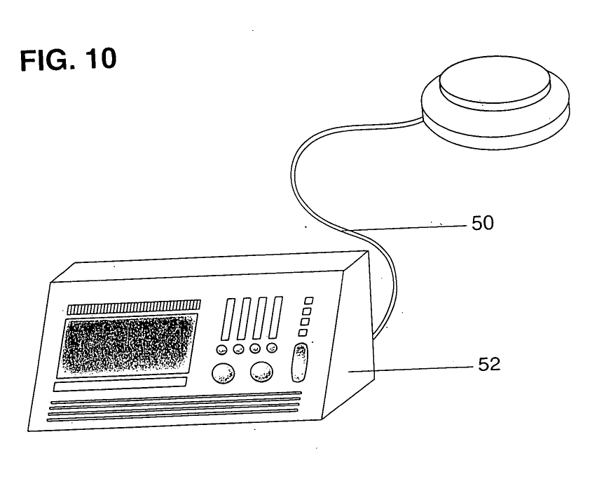

FIG. 10 shows regulation of the device's micromotor via a cable 50 connected to a control box 52.

### OPERATION—PREFERRED EMBODIMENT—FIGS. 3,8,10

The manner of using the device to perform panretinal photocoagulation (PRP) is consistent with known physician techniques in the current art Basically, a slit lamp laser delivery format is anticipated with the majority of treatments. Nothing, however, precludes using the concepts of the invention with other mechanisms of treatment such as the laser indirect or endoprobe systems. In the first instance the patient's cornea is usually anesthetized via topical drops. The examiner then applies a coupling agent to a fundus contact lens and places it on the subject's eye. In the preferred embodiment, which is related to U.S. Patent Appl. Ser. No. 11/024,308 to Eisenberg (2004), it is presumed ring laser photocoagulation lenses will be used. Assuming the mid peripheral retina is first chosen for treatment the physician will employ the fundus contact with the correct mirror angulations. At that juncture the duration of each laser pulse for each mirror of the contact lens can be set. This can be accomplished by control box 52 (FIG. 10). The same regulator will also effect position control. For the purposes of this treatment it is thought a broad beam laser will be most efficacious for administering therapy. While the current laser standard of care is in the visible light spectrum of 400-700 nm nothing prevent the device from being used in the infrared (810 nm) range. Nothing prevents the device from being used with any wavelength that subsequently is shown to be efficient for panretinal photocoagulation. Most often the power for a given spot diameter is then selected. After checking the focus with the patient's eye in primary position the macular anatomy can be seen in the central posterior portion of the lens through the slit lamp. Subsequently, the laser adaptor can be interposed in the beam path by sliding it into a stable position via shaft 44. (FIG. 8) At that point activating a trigger switch will then send, after being internally reflected by mirrors 22, 24 (FIG. 3), a specific laser pulse to the initial prism in the annulus of prisms configured on the ring fundus instrument by Eisenberg (2004). Upon completion of the initial laser firing the micromotor with edge gearing on its shaft 18 (FIG. 3) will rotate causing a fixed amount of rotation to be translated to solid disc 26 (FIG. 3). The angular extent of the solid disc's circular movement will be designed to accurately position the next laser pulse in the next circumferential mirror/prism within the contact lens. Again the laser will automatically fire delivering energy to the second mirror. And the process will be repeated in sequence such that all the mirrors in the fundus contact receive, pulses of energy. In this fashion a ring of laser spots will be delivered to the internal eye with the single triggering of the first shot. At that point the treating surgeon can then decide whether the same process should be repeated using a different ring fundus contact designed for additional therapy to the peripheral retina. By simply exchanging the correct contact on the patient's eye and activating the laser adjustor a new ring of automated photocoagulation can be delivered to a different location within the fundus if necessary. Sequential firing of the laser in conjunction with a device which diverts the light path automatically in a circular pattern will produce a faster delivery of panretinal photocoagulation. It will also reduce aiming errors in that the operator will not have to aim and trigger the laser one shot at a time. And it will reduce the coordination necessary for treatment. Assuming a broad beam laser is used with the preferred embodiment a full compliment of treatment currently requiring 60 minutes can be reduced to seconds.

### DESCRIPTION—ALTERNATIVE EMBODIMENTS

There are various possibilities with regard to alternative embodiments of the invention. The first involves the means of attaching the device to the laser delivery system. While the preferred embodiment discussed above favors a clip-on mechanism which allows the device to slide in and out of position other scenarios exist. The invention could be attached to a mobile or rotating arm which would facilitate bringing it to the proper position. Or the instrument might pivot or rotate on a fixed axis as a means for its proper placement. In addition, this laser adaptor has the capacity to be screwed into an assembly of lenses and mirrors comprising a laser delivery system. The methodology for fixating the instrument is not central to the spirit of the invention. Second, the regulation of the device has a number of possibilities. Instead of a cable connector, as described in the preferred embodiment, a wireless control could be used. Also, the electrical circuitry of the laser might be integrated so as to simultaneously modulate the micromotor. Thus, the alternative control systems for the invention are ancillary to the central thesis. And finally, one skilled in the art could construct a device mimicking the current invention with multiple laser beams arranged around a central axis. Each could be designed to fire or successively discharge in sequence. Individual barrels, each with a separate laser, could be arranged in a circular pattern and designed to discharge one at a time circumferentially. Alternatively, the simultaneous firing of all the barrels would then produce a ring of photocoagulation analogous to the current device. The same results might be obtained with beam splitters or a lens array inserted into a laser delivery system. In this fashion a single laser beam might be divided into multiple beams and anatomically configured to produce a ring of therapy consistent with panretinal photocoagulation.

ADVANTAGES

From the above description a number of advantages of our automating invention become evident:

a) The time to complete PRP will be markedly reduced. A rotating laser beam with repetitive firing in conjunction with a fundus contact lens containing a ring of mirrors will deliver treatments faster.

b) This apparatus will reduce the high degree of user coordination associated with the current methodologies of panretinal photocoagulation. It will not need the treating physician to manually aim a multitude of small laser spots one at a time.

c) Operator aiming errors will be diminished. The device will facilitate automatic delivery of laser energy to the interior eye without the consistent use of a micromanipulator, a headband, or an endoprobe.

d) The laser adaptor will reduce patient pain associated with PRP. Not only will faster treatments reduce discomfort the net energy delivered to the retina will likely be less. This is anticipated with a broader diameter laser beam than is currently used.

e) Patient safety will be increased with the instrument A quicker PRP process will result in less fatigue and anxiety for both the physician and patient. An automating process will further reduce misdirected energy as a result of operator errors.

f) The complications of laser surgery in PRP will be decreased. With possibly less energy delivered to the eye to complete therapy the complications of treatment such as visual field contraction, contrast sensitivity reduction, and nyctalopia should be diminished.

g) The machine will automate a process and a treatment which is heavily burdened by manual input

CONCLUSIONS, RAMIFICATIONS, SCOPE

Accordingly, the reader will see that the automating device of this invention can be used to provide a safer, faster, and more efficient method of performing panretinal photocoagulation. This is accomplished by mechanically rotating a laser beam in a circular configuration and triggering its timed repetitive firing sequentially. Used in conjunction with a broad beam laser and a fundus contact lens with its mirrors arranged in an annular pattern this will provide a ring of photocoagulation to the internal eye. The net effect will be to significantly reduce the time required to complete panretinal photocoagulation, reduce the operator coordination required, reduce doctor aiming errors, reduce patient pain, reduce patient and physician fatigue associated with the treatment, and reduce the complications of the procedure.

Although the above description contains many specificities these should not be construed as limitations on the scope of the invention. Instead, they should be viewed as exemplifications of the preferred embodiment. Many variations are possible in addition to the ones previously discussed. For example, the connection mechanism between the rotary disc and the fenestrated bottom plate might be different. A shaft could protrude superiorly from the stationary bottom disc through a hole beneath the central mirror. Alternatively, this would also allow the top plate to rotate on a fixed support In addition, the cross hair supports illustrated on the bottom plate do not have to be only in a reticule configuration. They may be increased in number and radiate from the center at fixed intervals like spokes on a wheel.

Thus the scope of the invention should be determined by the appended claims and their legal equivalents.

We claim:

1. A laser beam diverting device for automating panretinal photocoagulation, comprising:
(a) a solid rotary disc with edge gearing mounted with reflecting mirrors to redirect a laser beam,
(b) a micromotor with shaft gearing designed to enmesh and translate rotational force to said disc,
(c) a motor control apparatus to coordinate the sequential firing of timed laser pulses with the circular rotation of said disc,
whereby when placed within a laser delivery system the apparatus will function to fire a circular pattern of laser applications.

2. The beam diverting device in claim 1 wherein the solid rotary disc is supported by a fenestrated bottom plate.

3. The beam diverting device in claim 1 wherein the solid rotary disc, the micromotor, and the fenestrated bottom plate are enclosed within a metallic body casing.

4. The beam diverting device in claim 1 wherein the casing has a clip-on attachment mechanism to the laser delivery system.

5. The beam diverting device in claim 1 wherein the attachment mechanism is a mobile mechanical arm.

6. The beam diverting device in claim 1 wherein the mechanism of attachment is by threaded screws.

7. The beam diverting device in claim 1 wherein the micromotor is attached to the control box via a cable.

8. The beam diverting device in claim 1 wherein the micromotor is remotely controlled by circuitry within the laser delivery system.

9. The beam diverting device in claim 1 wherein the reflective surfaces on the mobile disc are prisms.

10. A laser work station apparatus, comprising:
(a) a body and means of attachment to a laser delivery system,
(b) a mobile plate mounted with reflective prisms to alter the pathway of a laser beam,
(c) a motor for producing rotational energy and a means of conveying rotary force to said plate,
(d) a control system to time laser shots in sequence with predetermined amounts of angular displacement in said plate,
whereby triggering the system will produce an automatic ring of laser discharges.

11. The laser work station apparatus in claim 10 wherein the mobile plate is supported by a fenestrated bottom plate.

12. The laser work station apparatus in claim 10 wherein the functional elements are enclosed within a casing.

13. The laser work station apparatus in claim 10 wherein the attachment method consists of sliding grooves and a clip-on mechanism.

14. The laser work station apparatus in claim 10 wherein the motor is attached to a control box via a cable.

15. A method of producing a ring of laser treatment, comprising the steps of:
(a) deflecting a laser beam path by a rotary disc mounted with reflecting mirrors,
(b) moving the rotary disc with a gear system attached to a micromotor,
(c) coordinating timed sequential laser pulses in conjunction with the movement of said disc,
whereby the laser will automatically fire a circular pattern of applications.

16. The method of claim 15 wherein said disc is supported by a stationary fenestrated bottom plate.

17. The method of claim 15 wherein said micromotor is connected to a control box via a cable.

18. The method of claim 15 wherein the device slides in and out of position lodged in grooves within a clip-on attachment.

19. The method of claim 15 wherein the system is enclosed within a metallic casing.

20. The method of claim 15 wherein the assembly is moved into position on a mechanical arm.
